(19) United States
(12) Patent Application Publication
(10) Pub. No.: US 2014/0108072 A1
(43) Pub. Date: Apr. 17, 2014

(54) Vendor Contract Assessment Tool

(71) Applicant: BANK OF AMERICA, Charlotte, NC (US)

(72) Inventors: Andrew J. McGowan, Charlotte, NC (US); Joan M. O'Donoghue, Pembroke, MA (US); James E. Rush, Charlotte, NC (US); William Jack Terrell, Lawrenceville, GA (US)

(73) Assignee: Bank of America, Charlotte, NC (US)

(21) Appl. No.: 13/654,079

(22) Filed: Oct. 17, 2012

(51) Int. Cl. G06Q 10/06

(52) U.S. Cl. 705/7.11

(57) ABSTRACT

A system and method that generates a graphical representation and allows the comparison between: 1) a set of contract or deal business requirements; 2) a contract or deal proposed by a vendor; and 3) a contract or deal that currently exists as viewed in the present time. The relative comparisons may be completed on key areas of the contract where key business requirements (KBRs) and metrics have been uniquely defined, targeted, and weighed. The set of contract or deal business requirements may also be defined as a Target Contract or a desired contract state. The contract or deal proposed by the vendor may be as defined as a Proposal Contract or a potential contract state. The contract or deal that currently exists may be defined as an Existing Contract or a current contract state.

### BACKGROUND

Currently, when negotiating and attempting to finalize a contract or a deal, there is an ad hoc set of requirements that may need to be met. During the negotiation and finalization process, it is difficult to determine where your party stands to get the deal done and finding success in the deal as compared to the set of previously defined requirements. This process makes it difficult to visualize and illustrate where the deal is compared to the target set of requirements across the board.

Contracts are continually negotiated and finalized with various vendors for various services and products. The existing deal is the old contract that the organization is currently operating under with the vendor, if a relationship currently exists. The proposal deal is the new contract that is being offered by the vendor and in some cases will be replacing an old or existing contract. The target deal is an organization's desired contract based off the business requirements and the old contract. However, the current way of finalizing a contract or a deal can be very time consuming, as well as very limiting as far as making decisions to move forward with the deal or areas to negotiate further. Accordingly, a system and method of visually identifying the shortcomings in the vendor's contract proposal in key areas, visually identifying the areas where the contract meets expectations, and allowing the pre-qualification of deals that are within the specified requirements would be advantageous.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, a computer-assisted method of assessing a vendor contract may include the following steps: establishing norms (key business requirements organized into a set of categories) associated with a specific IT classification; weighting, by a processor, the norms' key business requirements within each category; determining, using a processor, the norms' key business requirements scores and corresponding category scores; mapping, using a processor, the norms' category scores, wherein the mapping is on the visualization model; determining, using a processor, the scores for the existing contract utilizing the key business requirements and weightings established for its corresponding norms; mapping, using a processor, the existing contract's category scores, wherein the mapping is on the visualization model; determining, using a processor, a set of target contract scores for a set of key business requirements established by examining both the norms and existing contract; mapping, using a processor, the target contract's category scores, wherein the mapping is on the visualization model; determining, using a processor, a set of proposal contract scores for the same set of key business requirements utilized for the target contract; mapping, using a processor, a set of proposal contract category scores, wherein the mapping is on the visualization model; and identifying a set of shortcomings between the set of proposal contract category scores and the set of target contract category scores.

According to another aspect of the invention, a computer-readable storage medium storing computer-executable instructions that, when executed, cause a processor to perform a method that may include the following steps: receiving a set of key business requirements organized into a set of categories; weighting, by a processor, the set key business requirements; scoring, using a processor, the set of key business requirements for an existing contract, a target contract, and a proposal contract; mapping, using a processor, the scores of the set of key business requirements for the existing contract, wherein the mapping is on a visualization model that includes radar chart; whereby each leg of the radar corresponds to a category of key business requirements; mapping, using a processor, the scores of the set of key business requirements for the target contract, wherein the mapping is on the visualization model; mapping, using a processor, the scores of the set of key business requirements for the proposal contract, wherein the mapping is on the visualization model; and identifying a set of shortcomings between the scores of the set of key business requirements for the proposal contract and the scores of the set of key business requirements for the target contract.

According to another aspect of the invention, an apparatus may include at least one memory; and at least one processor coupled to the at least one memory and configured to perform, based on instructions stored in the at least one memory, the following steps: receiving a set of key business requirements organized into a set of categories; weighting, by a processor, the set key business requirements; determining, by a processor, an existing contract score, using a processor, for each of the key business requirements, wherein the existing contract score is determined by multiplying the weight for each key business requirement and a normalized score from 0-10 for each key business requirement associated with an existing contract; determining, by a processor, a target contract score, using a processor, for each of the key business requirements, wherein the target contract score is determined by multiplying the weight for each key business requirement and a normalized score from 0-10 for each key business requirement associated with a target contract; determining, by a processor, a proposal contract score, using a processor, for each of the key business requirements, wherein the proposal contract score is determined by multiplying the weight for each key business requirement and a normalized score from 0-10 for each key business requirement associated with a proposal contract; mapping, using a processor, the existing contract scores, wherein the mapping is on a visualization model that includes a set of legs for each of the set of categories of key business requirements; mapping, using a processor, the target contract scores, wherein the mapping is on the visualization model; mapping, using a processor, the proposal contract scores, wherein the mapping is on the visualization model; and identifying a set of shortcomings between the proposal contract scores and the target contract scores.

### BRIEF DESCRIPTION OF THE DRAWINGS

The present disclosure is illustrated by way of example and not limited in the accompanying figures in which like reference numerals indicate similar elements.

FIG. 1 shows an illustrative operating environment in which various aspects of the invention may be implemented.

FIG. 2 is an illustrative block diagram of workstations and servers that may be used to implement the processes and functions of certain aspects of the present invention.

FIG. 3A illustrates an example high-level process flow chart of a vendor contract assessment tool according to one or more aspects described herein.

FIGS. 3B and 3C illustrate an example method of a vendor contract assessment tool according to one or more aspects described herein.

FIG. 3D illustrates an illustrative table for use with an example embodiment according to one or more aspects described herein.

FIGS. 4 through 10C illustrate various illustrative tables for use with example embodiments according to one or more aspects described herein.

FIG. 11 illustrates another example method of a vendor contract assessment tool according to one or more aspects described herein.

FIGS. 12A and 12B illustrate other example high-level process flow charts of a vendor contract assessment tool according to one or more aspects described herein.

FIG. 13 illustrates another example method of a vendor contract assessment tool according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

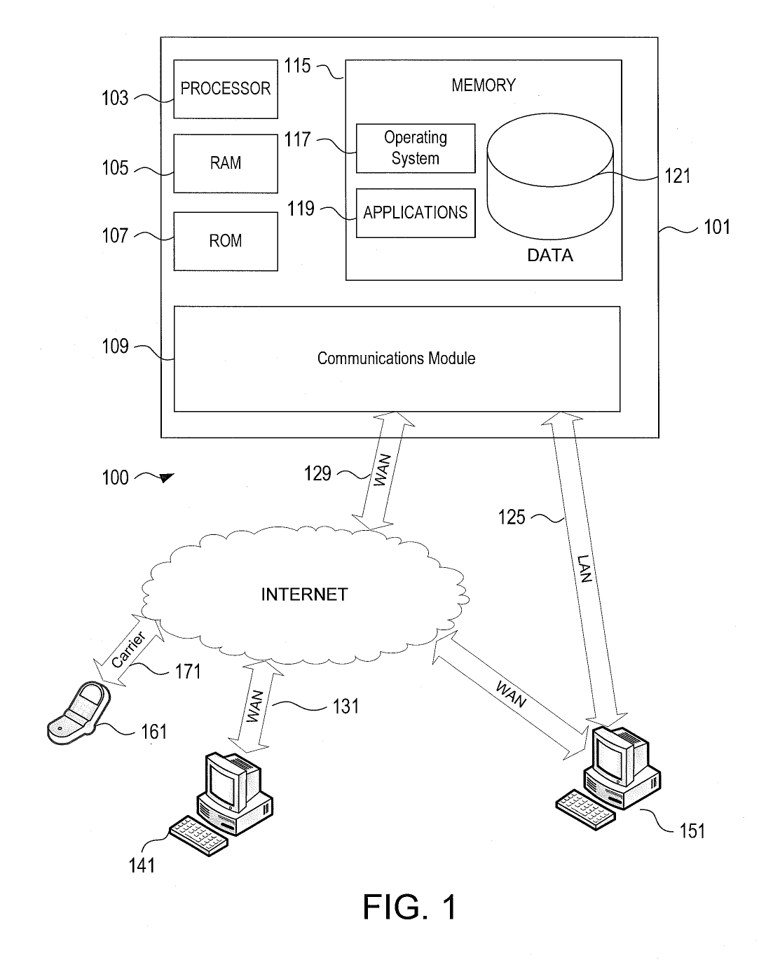

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality of the invention. The computing system environment 100 should not be interpreted as having any dependency or requirement relating to any one or combination of components shown in the illustrative computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). Database 121 may provide centralized storage of vendor information; contract information, both past and present; and the key business requirements/definitions that may be received from different points in system 100, e.g., computers 141 and 151 or from communication devices, e.g., communication device 161.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. Branch computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 is connected to the LAN 825 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the invention is contemplated. For example, aspects of the method steps disclosed herein may be executed on a processor on a computing device 101. Such a processor may execute computer-executable instructions stored on a computer-readable medium.

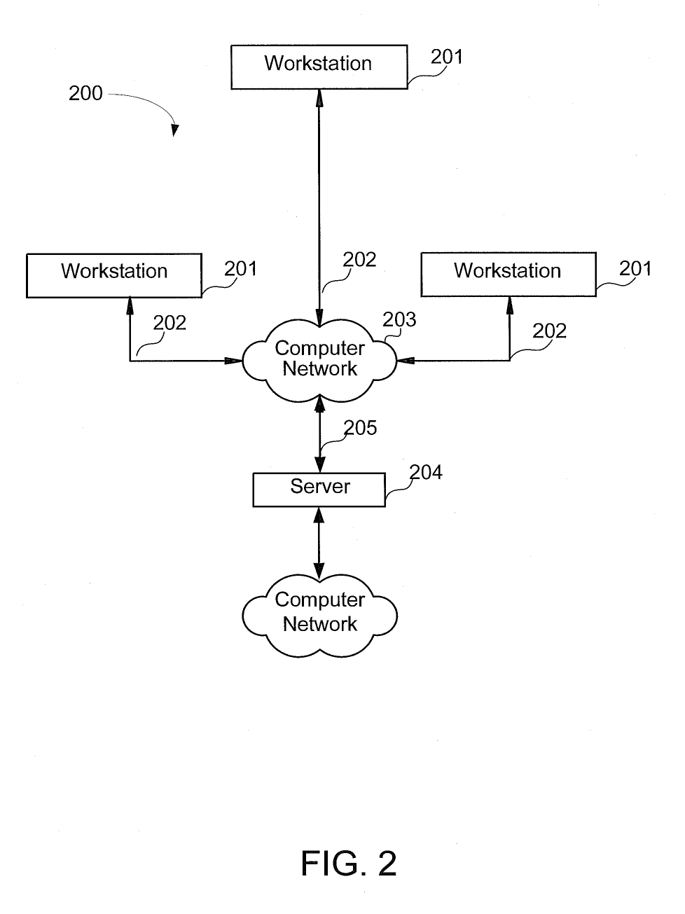

Referring to FIG. 2, an illustrative system 200 for implementing methods according to the present invention is shown. The system 200 may be a vendor/contract management system in accordance with aspects of this invention. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links. Connectivity may also be supported to a CCTV or image/iris capturing device.

The steps that follow in the figures may be implemented by one or more of the components in FIGS. 1 and 2 and/or other components, including other computing devices.

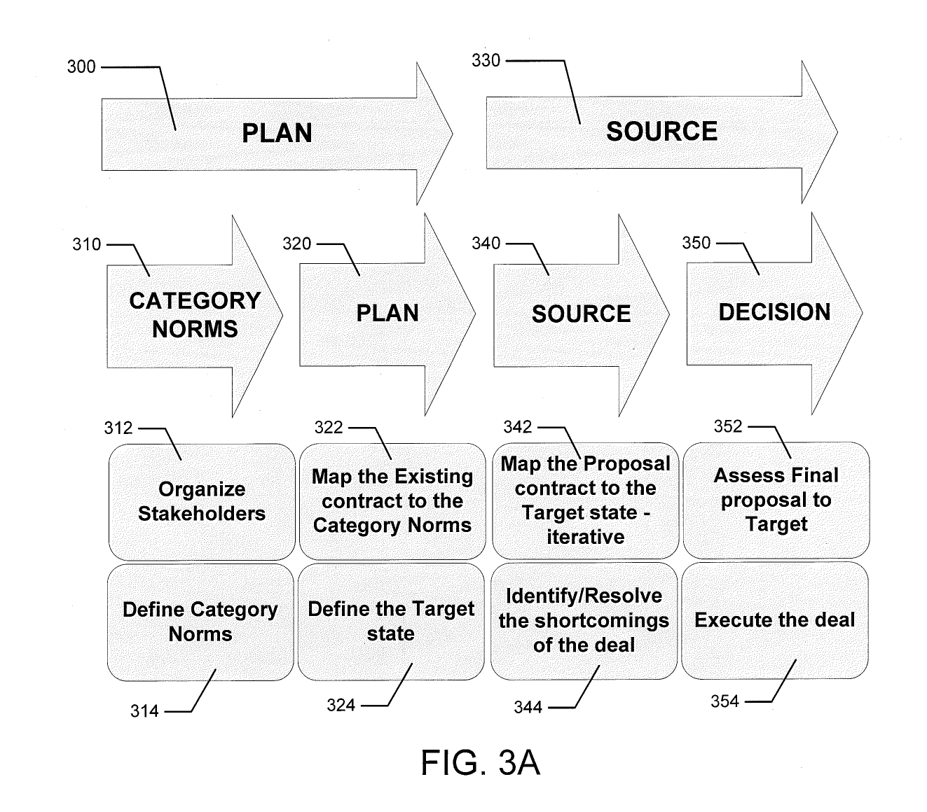

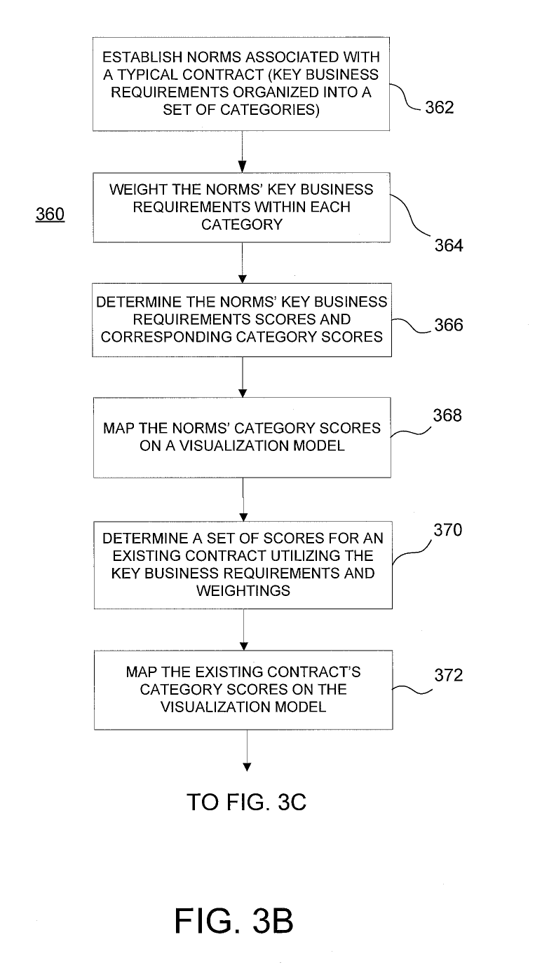

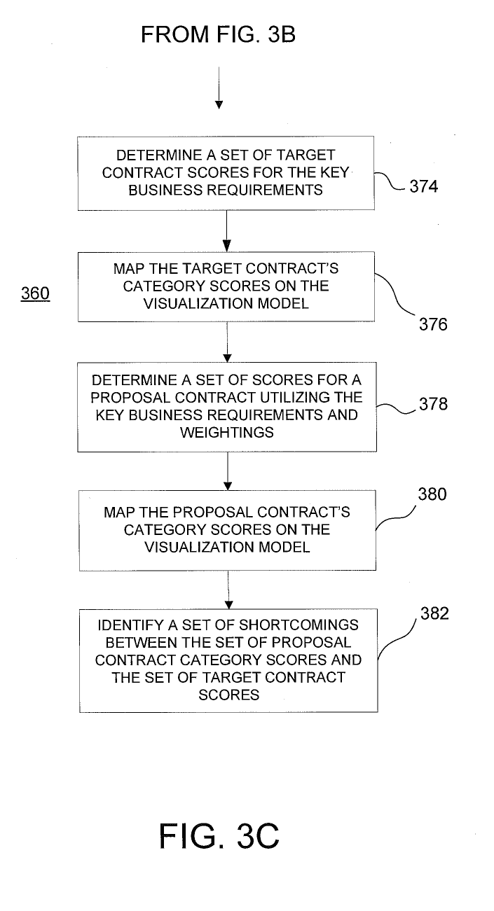

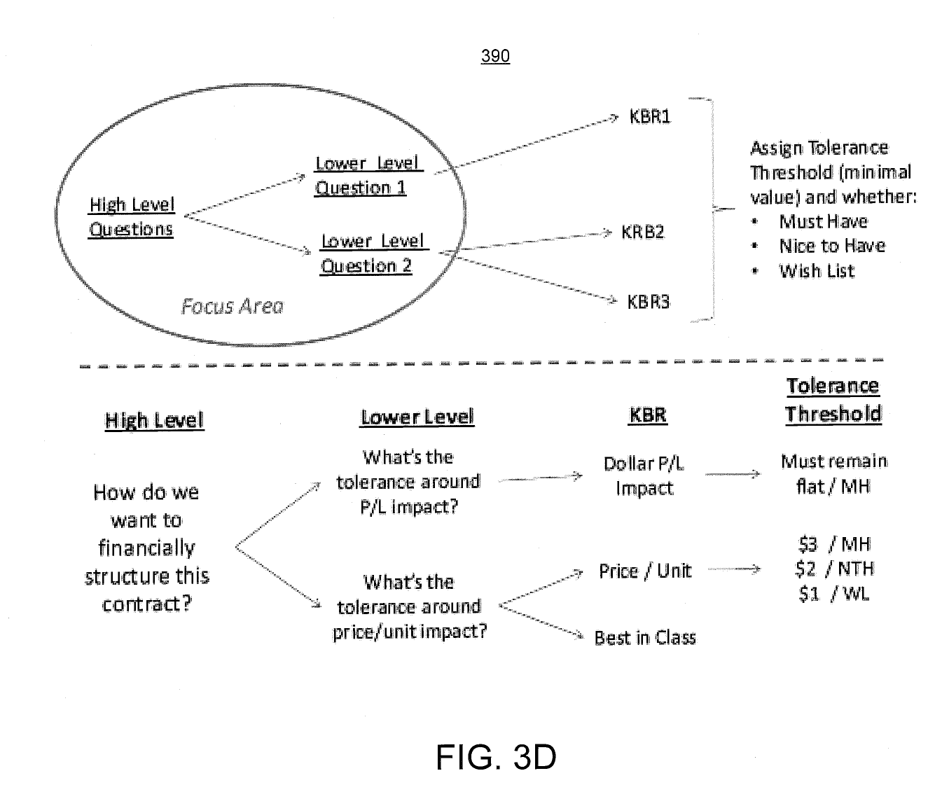

FIG. 3A illustrates a high-level process flow chart in accordance with aspects of this invention. Generally, FIG. 3A illustrates a sample process that defines systems and methods that generate a graphical representation and allows the comparison between: 1) a set of contract or deal business requirements; 2) a contract or deal proposed by a vendor; and 3) a contract or deal that currently exists as viewed in the present time. The relative comparisons may be completed on key areas of the contract where key business requirements (KBRs) and metrics have been uniquely defined, targeted, and weighed. The set of contract or deal business requirements may also be defined as a Target Contract or a desired contract state. The contract or deal proposed by the vendor may be as defined as a Proposal Contract or a potential contract state. The contract or deal that currently exists may be defined as an Existing Contract or a current contract state. FIGS. 3B and 3C illustrate a flow chart 360 for systems and methods in accordance with aspects of this invention. In a first step 362, the system and methods may include the step of establishing norms associated with a specific IT classification, wherein the norms may be key business requirements that are organized into a set of categories. In another step 364, the system and methods may include the step of weighting the norms' key business requirements within each category. In another step 366, the system and methods may include the step of determining the norms' key business requirements scores and corresponding category scores. In another step 368, the system and methods may include the step of mapping the norms' category scores on a visualization model. In another step 370, the system and methods may include the step of determining a set of scores for an existing contract utilizing the key business requirements and weightings established for its corresponding norms. In another step 372, the system and methods may include the step of mapping the existing contract's category scores on the visualization model. In another step 374, the system and methods may include the step of determining a set of target contract scores utilizing the key business requirements and weightings. In another step 376, the system and methods may include the step of mapping the target contract's category scores on the visualization model. In another step 378, the system and methods may include the step of determining a set of scores for a proposal contract utilizing the key business requirements and weightings. In another step 380, the system and methods may include the step of mapping the proposal contract's category scores on the visualization model. In another step 382, the system and methods may include the step of identifying a set of shortcomings between the set of proposal contract category scores and the set of target contract scores. The steps as described above will be explained in more detail below. Additionally, the steps as described and listed above are not all inclusive or all required to perform the systems and methods in accordance with this invention.

As illustrated in FIG. 3A, the process includes both a planning phase 300 and a sourcing phase 330. Underneath the planning phase 300 are two sub-phases, category norms 310 and plan 320. Underneath the sourcing phase 330 are also two sub-phases, source 340 and decision 350. Each of the sub-phases may generally include a number of steps that make up the sub-phase.

As illustrated in FIG. 3A, the category norm sub-phase 310 includes a first step of organizing the stakeholders 312. The stakeholders may be those individuals or organizations which have an interest in the contract and/or the completion and finalization of the contract. The stakeholders may include, but not be limited to the following: process owner or owner of the area in which the contract will be executed, sourcing managers, network or computing architecture, vendor managers, enterprise vendor managers, vendor administration, vendor relationship managers, risk/compliance managers, and finance. Other stakeholders may be contemplated with this step in accordance with aspects of this invention.

The category norm sub-phase 310 may also include another step of defining category norms 314. Category norms may be defined as those categories or key business requirements (KBRs) organized into a set of categories. The categories or KBRs may be important to the contract and typical to that kind of contract. The norms' key business requirements within each category may be established ahead of time. The category norms will help to get the process started. The category norms may be a set of KBRs that are typical and can be changed later if necessary or desired.

As illustrated in FIG. 3D, when determining the category norms or the key business requirements, the key business or key stakeholders may be asked to assist with this process. The table 390 illustrates an example process to determine the key business requirements by first utilizing a set of high-level questions. From this set of high-level questions, a set of lower-level questions for each high-level question may be utilized, for example a lower-level question 1, a lower-level question 2, and so on. Then from those lower-level questions, one or more key business requirements may be determined, such as KBR1, KBR2, KBR 3, and so on. With the KBRs, there may then be a tolerance threshold or level assigned, such as a minimum value and whether the KBR is: a must have, a nice to have, or on the wish list.

In an example situation, a high-level question may be: “How do we want to financially structure this contract?” Two lower-level questions that may come from that high-level question may be: 1) What's the tolerance around profit/loss impact?; and 2) What's the tolerance around price/unit impact? From the first lower-level question, a possible KBR may be determined as “Dollar profit/loss impact” with an example tolerance threshold that it must remain flat, which may be a must have KBR. From the second lower-level question, a possible KBR may be determined as “price/unit” with example tolerance thresholds of $3 as a must have, $2 as a nice to have, and $1 as a wish list. From the second lower-level question, another possible KBR may be determined as “best in class.” These questions are just examples as to the process of using high-level questions and lower-level questions with tolerance thresholds to help determine the key business requirements and the category norms.

The category norms may be also be defined as a set of metrics in order to measure the Existing Contract, Target Contract, and Proposal Contract against each other. Metrics may be defined into main categories which may be used as legs or components of a visualization grid as will be described further below. These metrics may be chosen based on the KBR categories defined by the stakeholders. The KBRs can also have several subcategories for each category.

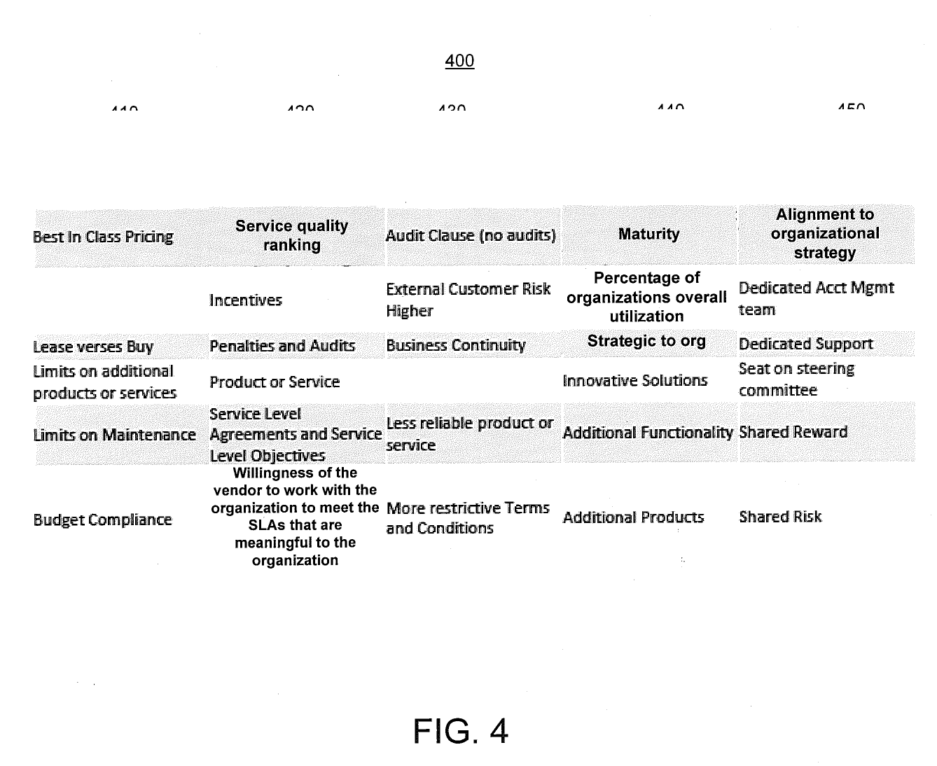

FIG. 4 illustrates a sample chart 400 of KBRs and metrics for categories and subcategories. As illustrated in the sample chart 400, there may be five different categories of KBRs, financial 410, service quality 420, risk, 430, capabilities 440, and partnership 450. Different categories of KBRs may be utilized without departing from this invention.

The sub-categories for the financial category 410 (or pricing) may include but not be limited to: best in class pricing, lease versus buy, limits on additional products or services, limits on maintenance, and budget compliance. Other sub-categories under the KBR category of finance 410 may be utilized without departing from this invention, such as financing terms and percentage of budgeted funds.

The sub-categories for the service quality category 420 may include but not be limited to: service quality rankings, incentives, audits, product or service, service level agreements and service level objectives, willingness of the vendor to work with the organization to meet the service level agreements that are meaningful to the organization. Other sub-categories under the KBR category of service quality 420 may be utilized without departing from this invention.

The sub-categories for the risk category 430 may include but not be limited to: audit clause (no audits); external customer risk higher; business continuity; less reliable product or service; more restrictive terms and conditions. Other sub-categories under the KBR category of risk 430 may be utilized without departing from this invention.

The sub-categories for the capabilities category 440 (or competitive capability) may include but not be limited to: maturity, percentage of organizations overall utilization, strategic to the organization, innovative solutions, additional functionality, and/or additional products. Other sub-categories under the KBR category of capabilities 440 may be utilized without departing from this invention, such as ratio strategic/non-strategic products, percentage desired population covered, and percentage variability.

The sub-categories for the partnership category 450 (or teamwork) may include but not be limited to: alignment to the organization's strategy, dedicated account management team, dedicated support, seat on steering committee, shared reward, and/or shared risk. Other sub-categories under the KBR category of partnership 450 may be utilized without departing from this invention, such as training

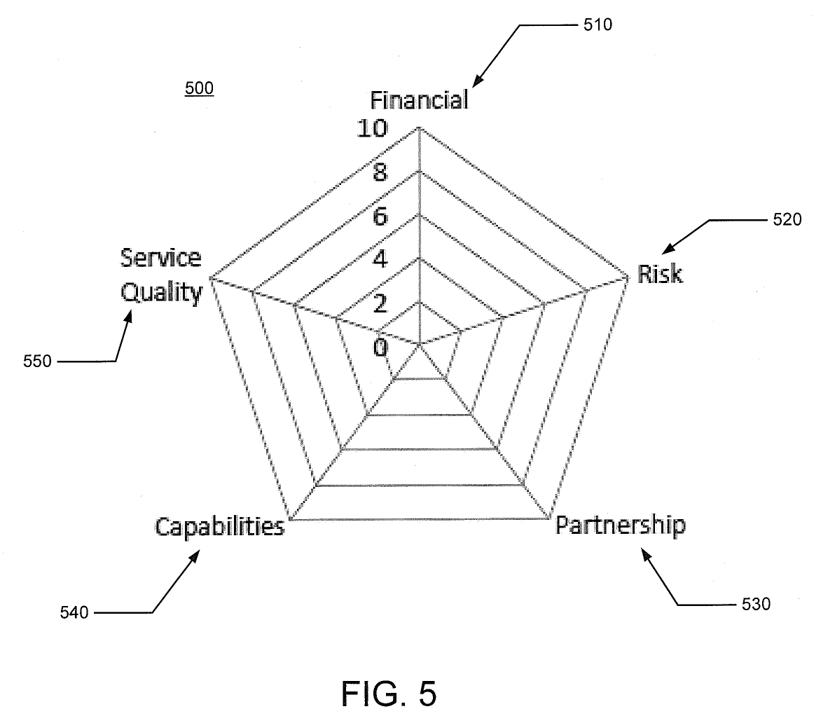

FIG. 5 illustrates a sample visualization grid 500 or snapshot utilizing each of the categories of KBRs from the above example. The use of the visualization grid 500 will be explained in more detail below. The visualization model may be in the form of a radar chart, whereby each leg of the radar corresponds to a category. For example, each of the KBR categories are shown and mapped on the visualization grid 500 as one of the legs: financial 510, risk 520, partnership 530, capabilities 540, and service quality 550. Generally, each visualization grid 500 or snapshot may be developed through the brainstorming with stakeholders the key business requirements that would need to go into a vendor contract. Then, those key business requirements may be sorted into logical groupings (or categories) to determine the legs of the snapshot diagram. Next, an owner may be established for each category. And next, weights may be assigned by each group to the key business requirements within each category. Finally, each of the categories and sub-categories may be scored, as will be described and detailed below.

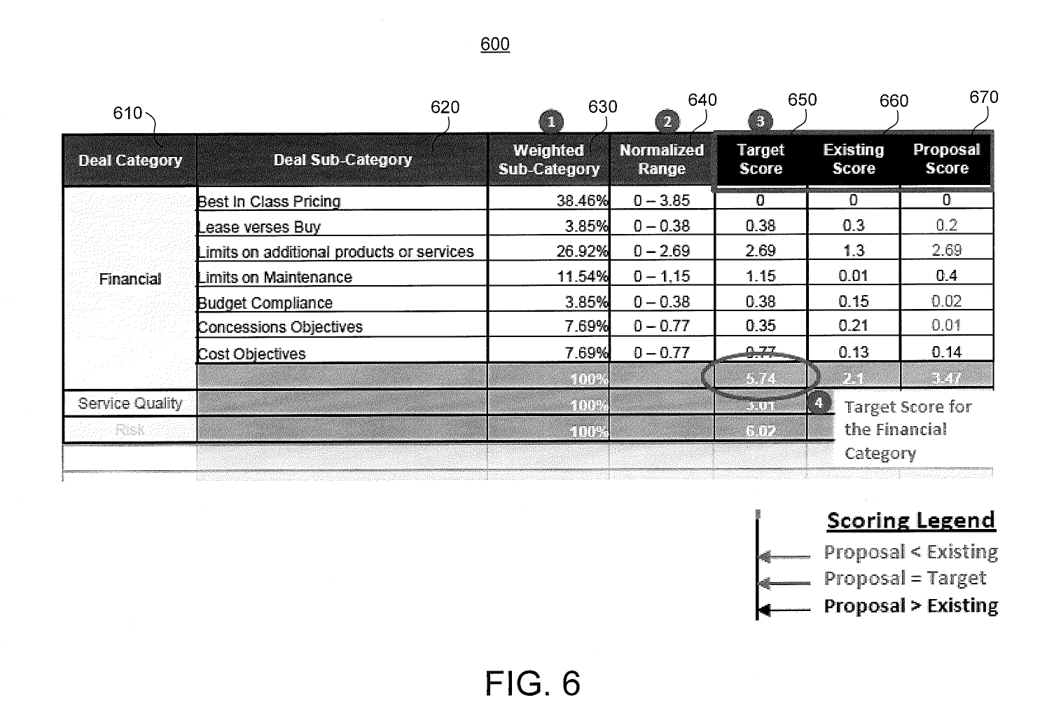

FIG. 6 illustrates a weighting table 600 that illustrates a sample method of weighting and scoring the metrics or the categories and sub-categories in accordance with aspects of this invention. As illustrated in the weighting table 600, there are seven different columns: Deal Category 610, Deal Sub-Category 620, Weighted Sub-Category 630, Normalized Range 640, Target Score 650, Existing Score 660, and Proposal Score 670. Additional, or less, columns may be utilized with this table without departing from this invention. In this example, the deal category 610 is financial, with the sub-categories 620 being best in class pricing, lease versus buy, limits on additional products or services, limits on maintenance, budget compliance, concessions objectives, and cost objectives.

As illustrated in FIG. 6, the weighting and scoring the metrics may include the following steps. First, labeled with a “1”, the deal sub-categories 620 may be weighted by the stakeholders, by determining a weighted sub-category 630 percentage for each deal sub-category 620. When completing this step, it is important to ensure that each sub-category weight 630 adds up to 100% for each deal category 610.

Second, labeled with a “2”, a normalized range 640 is determined by taking the weighted sub-category percentages and defining a normalized range 640 (0 to 10 point scale) to score. To find the normalized ranges 640, the weighted sub-categories 630 may be divided by 100. Each of these normalized scores (target score 650, existing score 660, and proposal score 670) will fall within the normalized ranges 640.

Third, labeled with a “3”, a normalized score may be determined for each of the three different scores, target score 650, existing score 660, and proposal score 670. Various methods may be utilized to determine the normalized score. The weighted score for each of the different scores may be calculated by multiplying the weighted sub-category 630 by the normalized score. In one aspect of the invention, for binary (yes or no) questions or sub-categories 620, the score may either be 0% (no) or 100% (yes) of the maximum value in the normalized range. For example, “Did we achieve best in class pricing?” Answering “no” is equivalent to 0% of the maximum value, or 3.85, which is then calculated as 0 for the sub-category of best in class pricing. Answering “yes” is equivalent to 100% of the maximum value, or 3.85, which is then calculated as 3.85 for the sub-category of best in class pricing. In another aspect of the invention, for raw calculations, the score may be determined by the achievement level in terms of a percentage of the maximum value in the normalized range. For example, “How many of the 100 concessions did we receive?” Answering 46 concessions is equivalent to 46% of the maximum value, or 0.77, which is then calculated as 0.35 for the sub-category score for concessions objectives.

Fourth, labeled by a “4”, the target score 650 for each category may be generated by adding all the weighted scores of the sub-categories. The existing score 660 and the proposal score 670 may be generated in a similar manner.

Following the defining the category norms, FIG. 3A illustrates the plan sub-phase 320 which may include a first step of mapping the contract to the contract norms 322. In this step the visualization model or snapshot tool 500 as illustrated in FIG. 5 may be utilized. The weighted scores determined previously may then be mapped on the legs for each category. For example, the weighted scores for financial category may be mapped along the Financial leg 510. The weighted scores for the risk category may be mapped along the Risk leg 520. The weighted scores for the partnership category may be mapped along the Partnership leg 530. The weighted scores for the capabilities category may be mapped along the Capabilities leg 540. The weighted scores for the service quality category may be mapped along the Service Quality leg 550.

It should be understood that more or less legs may be utilized with the visualization model or snapshot tool 500 without departing from this invention. For example, the snapshot tool 500 illustrated in FIG. 5 utilizes five categories and five legs, and is therefore represents a five-sided polygon, such as a pentagon. In another example without departing from this invention, the visualization model or snapshot tool 500 may utilize four categories and four legs, and may therefore represent a four-sided polygon, such as a rectangle (or square). In another example without departing from this invention, the visualization model or snapshot tool 500 may utilize six categories and six legs, and may therefore represent a six-sided polygon, such as a hexagon. In another example without departing from this invention, the visualization model or snapshot tool 500 may utilize eight categories and eight legs, and may therefore represent a eight-sided polygon, such as a octagon.

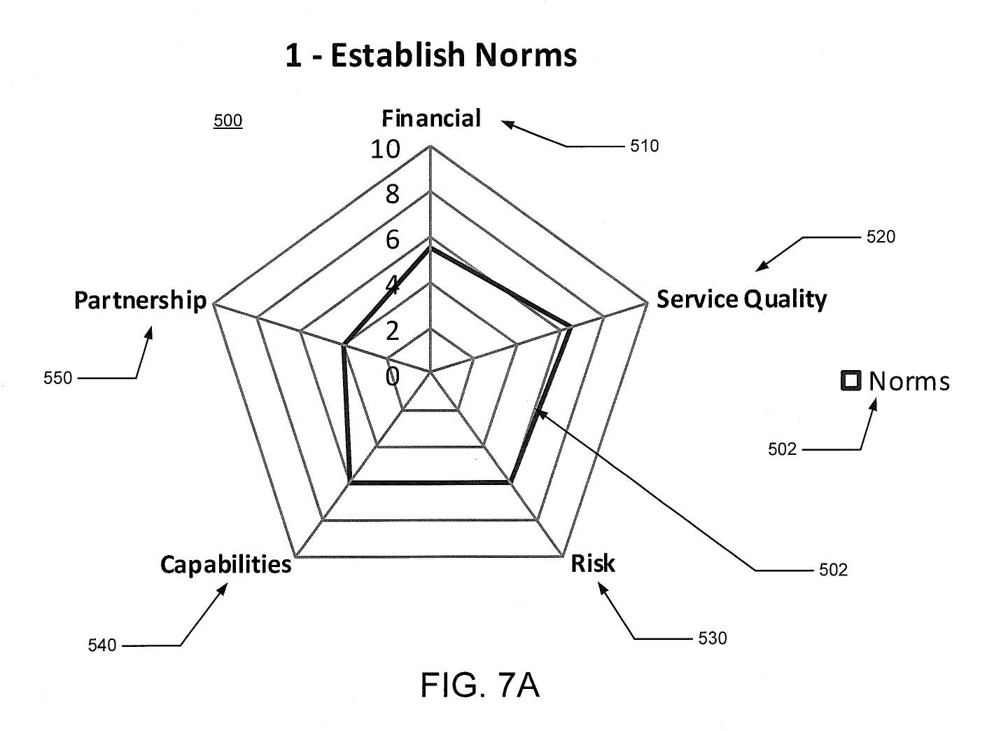

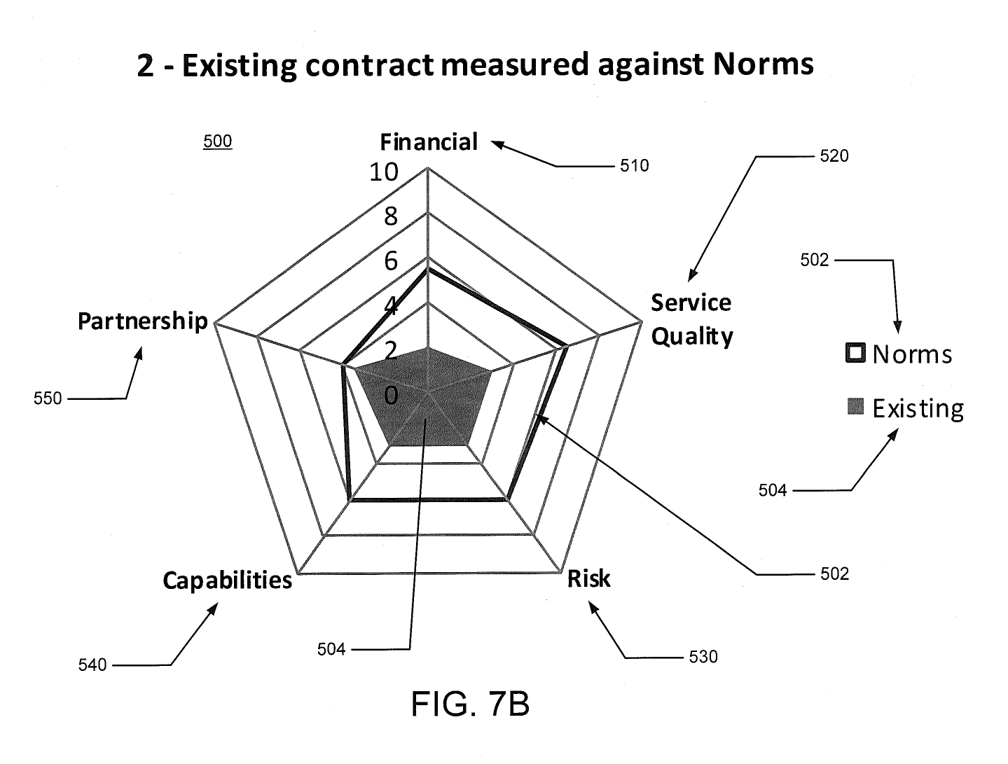

FIGS. 7A and 7B illustrate example visualization models or snapshot tools 500 in accordance with aspects of this invention. FIG. 7A illustrates a visualization model 500 with a sample of the category norms 502 defined and mapped on the visualization model. FIG. 7B illustrates a visualization model 500 with a sample of the existing contract 504 measured against the category norms 502. As is illustrated in FIG. 7B, the existing contract 504 does not meet the category norms 502 in all but one category, partnership 540.

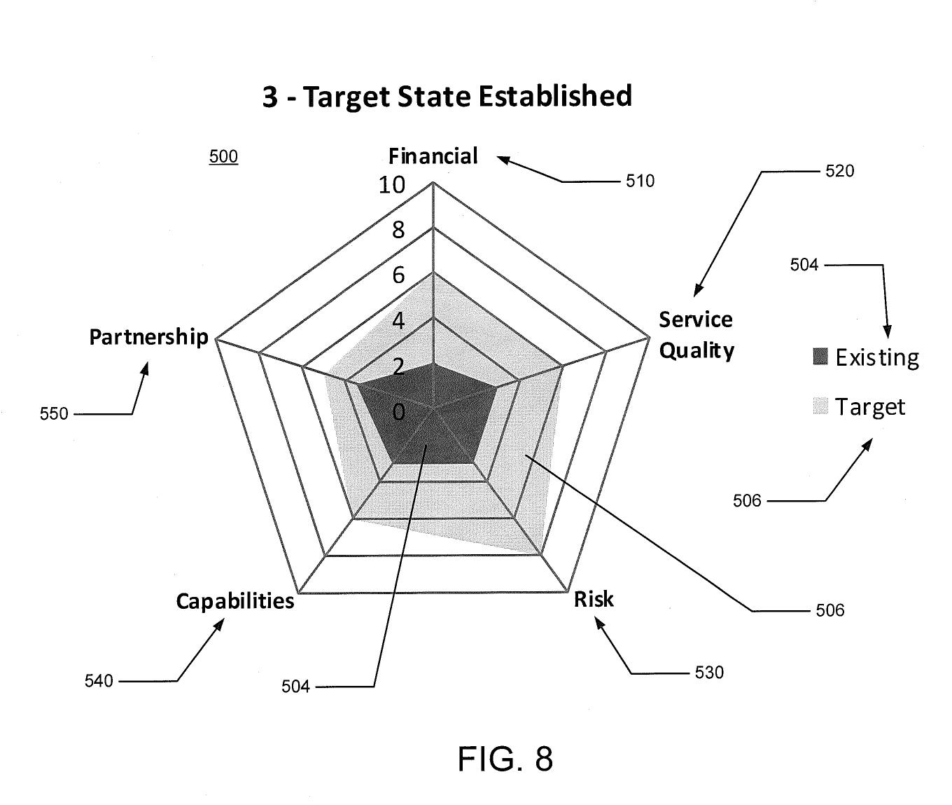

Following the mapping the existing contract to the category norms step 322, FIG. 3A illustrates the next step in the plan sub-phase 320, define the target state 324. During the define the target state step 324, the stakeholders and/or owners of each category determine the target for each of the categories. For example, the stakeholders and/or owners of the Finance category 510 determine an expected or desired value for the Finance category 510. Additionally, the stakeholders and/or owners of the Service Quality category 520 determine an expected or desired value for the Service Quality category 520. Additionally, the stakeholders and/or owners of the Risk category 530 determine an expected or desired value for the Risk category 530. Additionally, the stakeholders and/or owners of the Capabilities category 540 determine an expected or desired value for the Capabilities category 540. Additionally, the stakeholders and/or owners of the Partnership category 550 determine an expected or desired value for the Partnership category 550. FIG. 8 illustrates an example visualization model or snapshot tool 500 with the target state 506 established. FIG. 8 also illustrates the existing contract 504, which visually shows how the existing contract 504 compares to the target state or target contract 506. In the specific example as shown in FIG. 8, the existing contract 504 does not meet the requirements or desired target state or target contract 506.

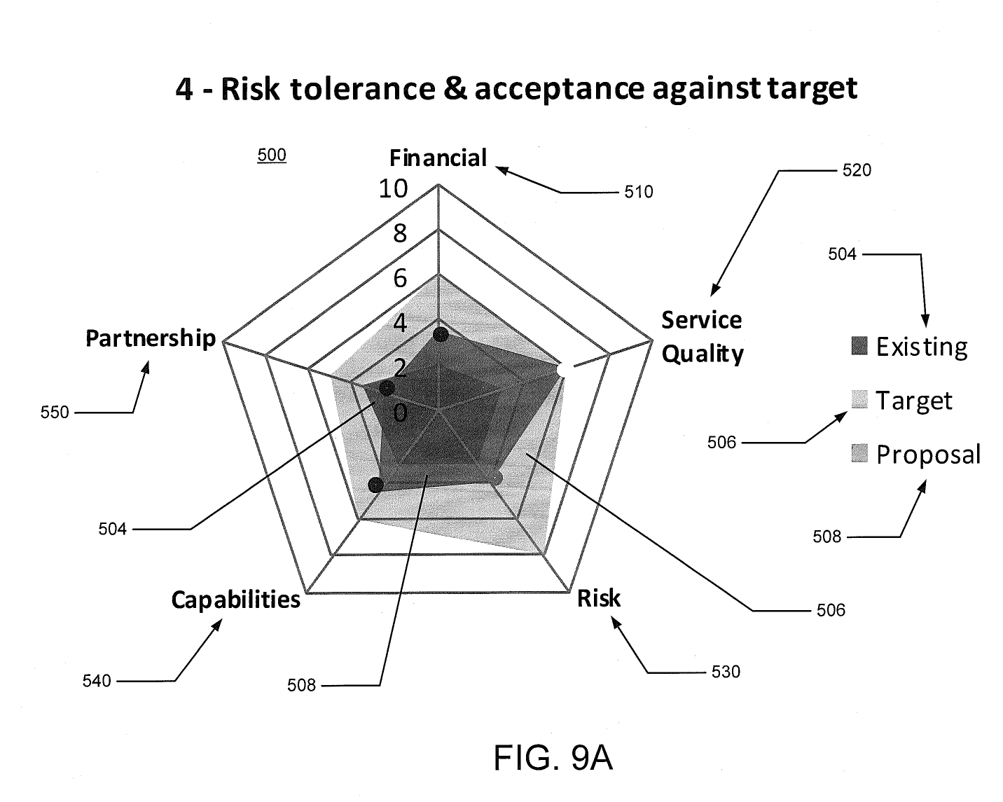

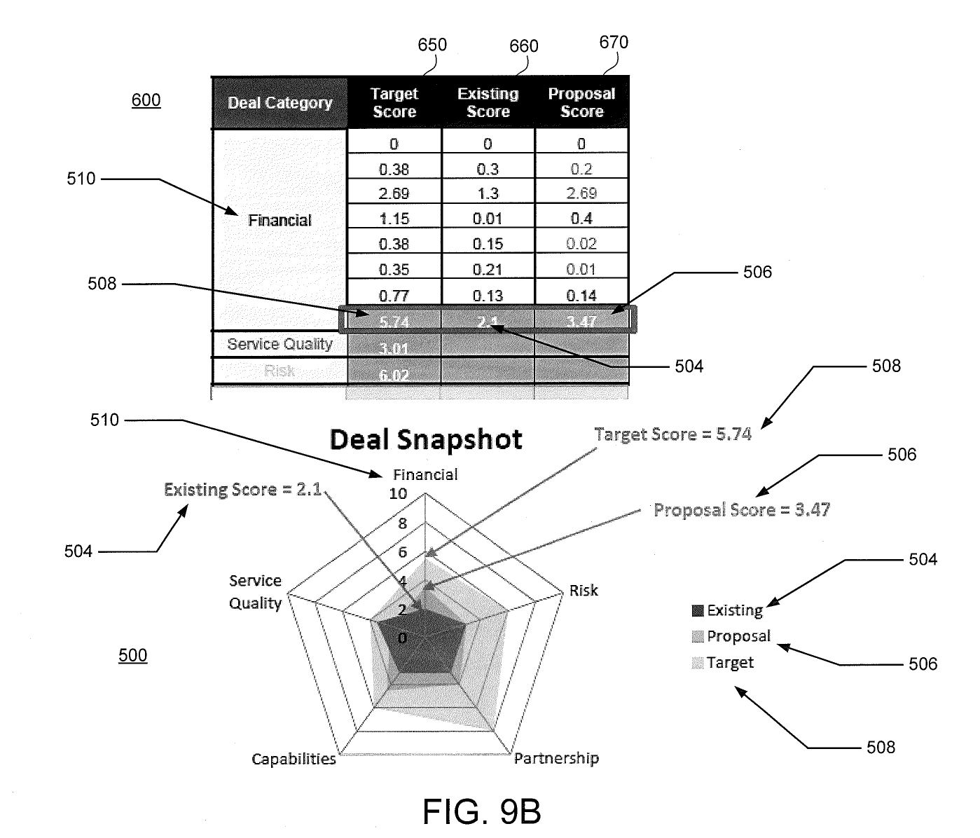

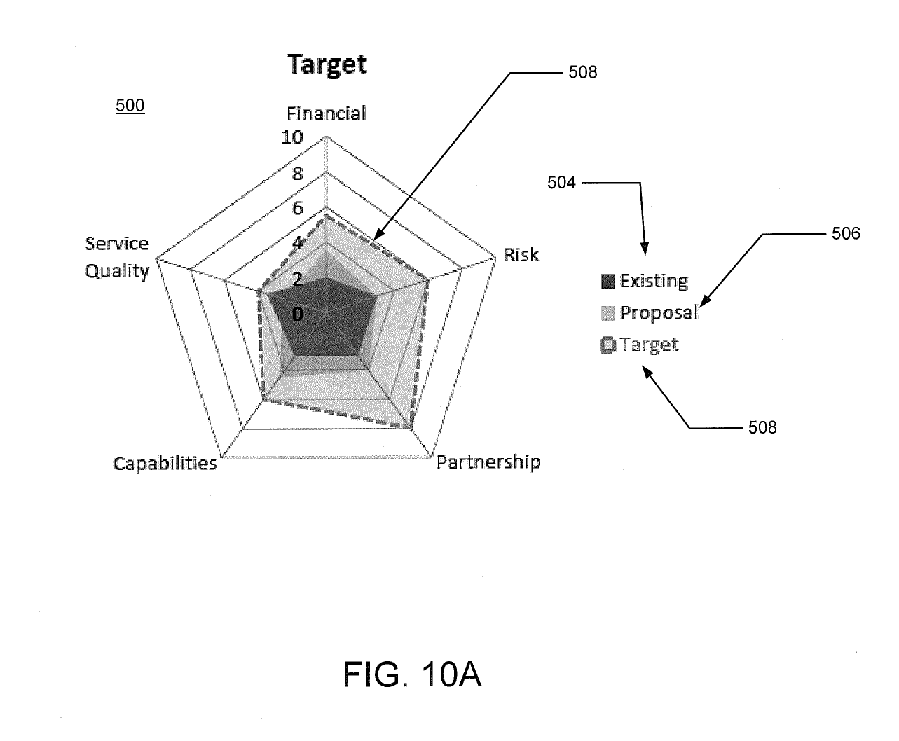

Following the defining the target state step 324, FIG. 3A illustrates the source sub-phase 340 which may include a first step of mapping the proposal contract to the target state 342. In this step the visualization model or snapshot tool 500 as illustrated in FIG. 5 may be utilized. As was described above and illustrated in FIG. 6, the proposal contract weighted scores 670 and the target state weighted scores 650 may be utilized for this step 342. FIG. 9A illustrates an example visualization model or snapshot tool 500 that maps the proposal contract 508, the existing contract 504, and the target contract 506. In the specific example as shown in FIG. 9A, the proposal contract 508 does meet the target contract 506 in any of the categories except for the Service Quality category 520. In all other categories, the Financial category 510, the Risk category 530, the Capabilities category 540, and the Partnership category 550, the proposal contract 508 does not meet the target contract 506.

FIG. 9B illustrates an example of the weighting table 600 as illustrated in FIG. 6 with the target weighted score 650, the existing weighted score 660, and the proposal weighted score 670. FIG. 9B further illustrates the plotting of these scores on the visualization model or snapshot tool 500 along the Financial leg 510. The existing score 504, target score 506, and proposal score 508 are plotted along the Financial leg 510 of the visualization model or snapshot tool 500. This same process or method may be further utilized for each of the other categories or legs utilized with the visualization model or snapshot tool 500.

Following the mapping the proposal contract to the target state 342, FIG. 3A illustrates the next step in the source sub-phase 340, identify/resolve the shortcoming of the proposed contract 344. During the identify/resolve the shortcomings of the proposed contract step 344, the stakeholders and/or the owners of each of the categories first identifies which categories proposed contract score is less than the target score. This can be easily accomplished by viewing the visualization model or the snapshot tool 500. The visualization model or the snapshot tool 500 may give executives the ability to quickly assess if the proposal contract meets the criteria set by the company without looking at the details of the terms and conditions. The visualization model or the snapshot tool 500 provides a clear understanding of what the contract/deal is trying to achieve. Additionally, the visualization model or the snapshot tool 500 provides a quick visual view of where the organization stands in terms of achieving the target. Additionally, the visualization model or the snapshot tool 500 provides a mechanism to allow for pre-approval of a deal if the organization meets or exceeds all targets.

After the stakeholders or category owners identify the shortcomings of the contract, the stakeholders or category owners may attempt to resolve these shortcomings. The visualization model or snapshot tool 500 may provide the stakeholders or category owners the ability to target specific areas or categories of the proposal contract. The stakeholders or category owners may then focus on these categories in order to attempt to resolve the shortcomings of the proposal contract.

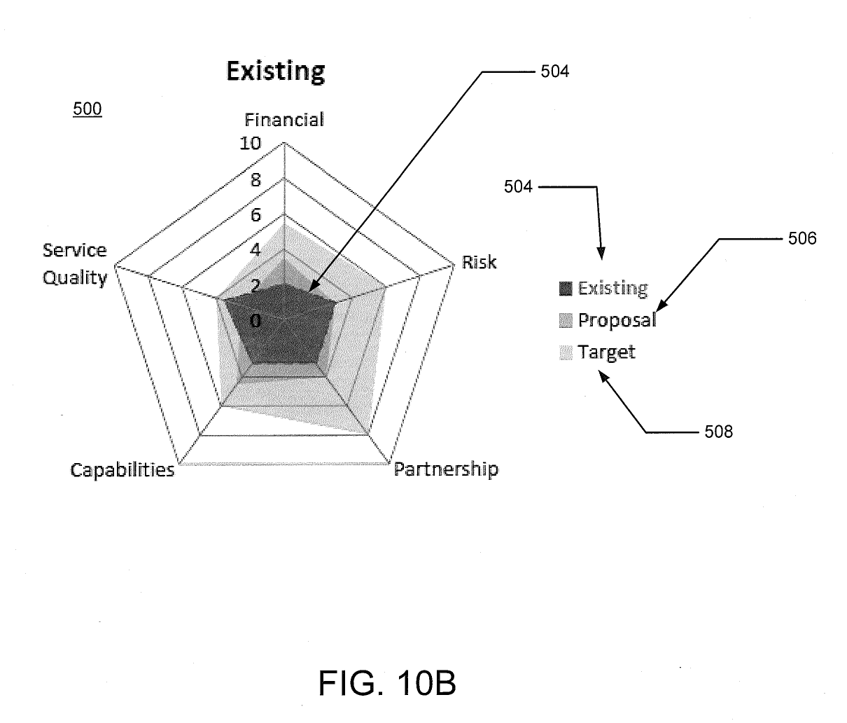

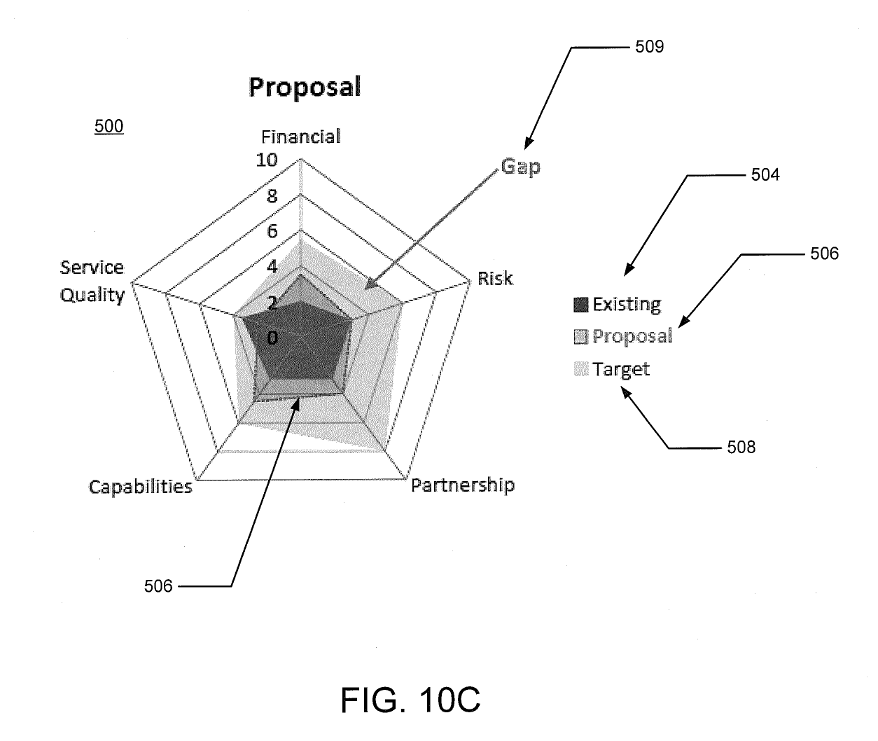

Following the identifying/resolving the shortcomings of the contract step 344, FIG. 3A illustrates the final sub-phase of decision 350 which may include a first step of assessing the final proposal to the target 352. FIGS. 10A, 10B, and 10C illustrate the assessing the final proposal to the target step 352 utilizing the visualization model or the snapshot tool 500. FIG. 10A illustrates the target state 508, which shows the boundary area where an organization wants the proposal contract 506 to lie within. FIG. 10B illustrates the existing contract 504 which defines an area that shows the current state of the organization's contract with the vendor. FIG. 10C illustrates the proposal contract 506 which shows the areas where there is no overlap (if any) and overextends outside the area defined by the existing contract 504. The gap 509 illustrated is where the proposal contract 506 comes up short and is defined as the area between the proposal contract 506 and the target contract 508.

The next step following the assessing the final proposal to the target step 352 is executing the deal or contract 354. During this step, when the proposal contract meets or exceeds the target contract in all categories, the organization may execute the contract. The organization may execute the contract in other situations even when the proposal contract does not meet or exceed all of the categories of the target contract.

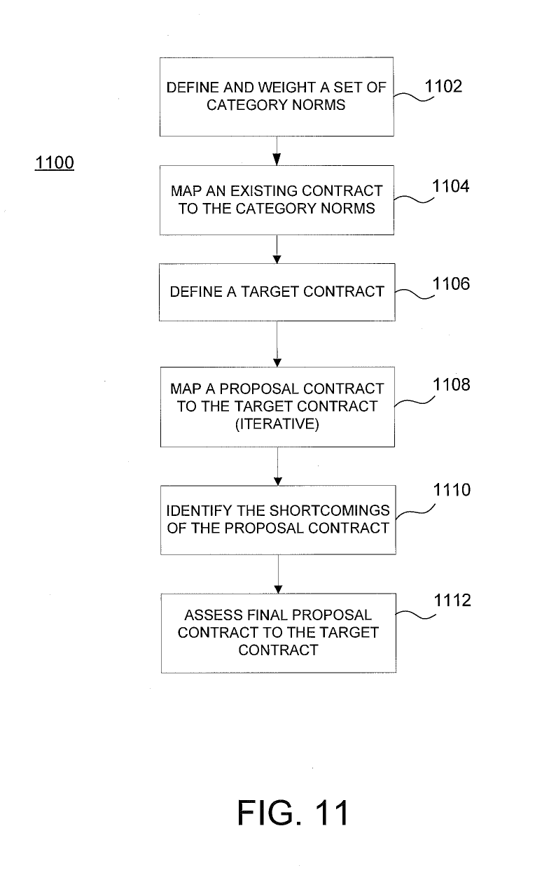

FIG. 11 may be similar to and/or based on FIG. 3A and the description regarding FIG. 3A. FIG. 11 illustrates a flow chart 1100 for systems and methods that generate a graphical representation and allows the comparison between: 1) a set of contract or deal business requirements; 2) a contract or deal proposed by a vendor; and 3) a contract or deal that currently exists as viewed in the present time. In a first step 1102, the system and methods may include the step of defining and weighting a set of category norms. In a second step 1104, the system and methods may include the step of mapping an existing contract to the category norms. In a third step 1106, the system and methods may include the step of defining a target contract. In a fourth step 1108, the system and methods may include the step of mapping a proposal contract to the target contract as an iterative process. In a fifth step 1110, the system and methods may include the step of identifying shortcomings of the proposal contract. In a sixth step 1112, the system and methods may include the step of assessing the final proposal contract to the target contract.

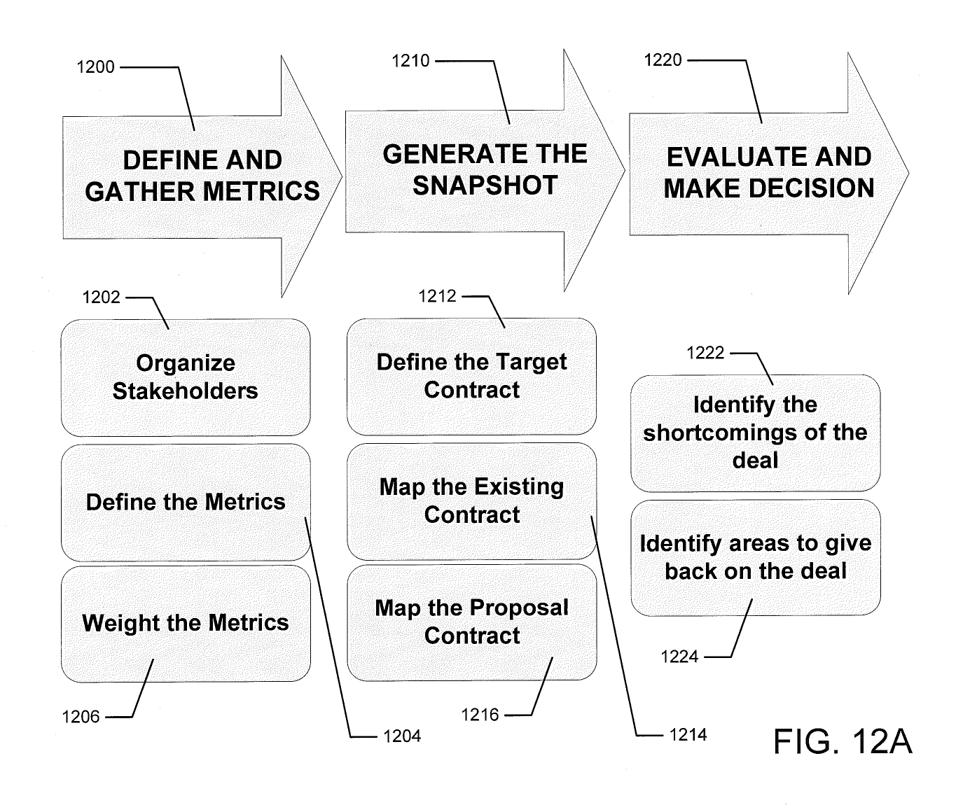

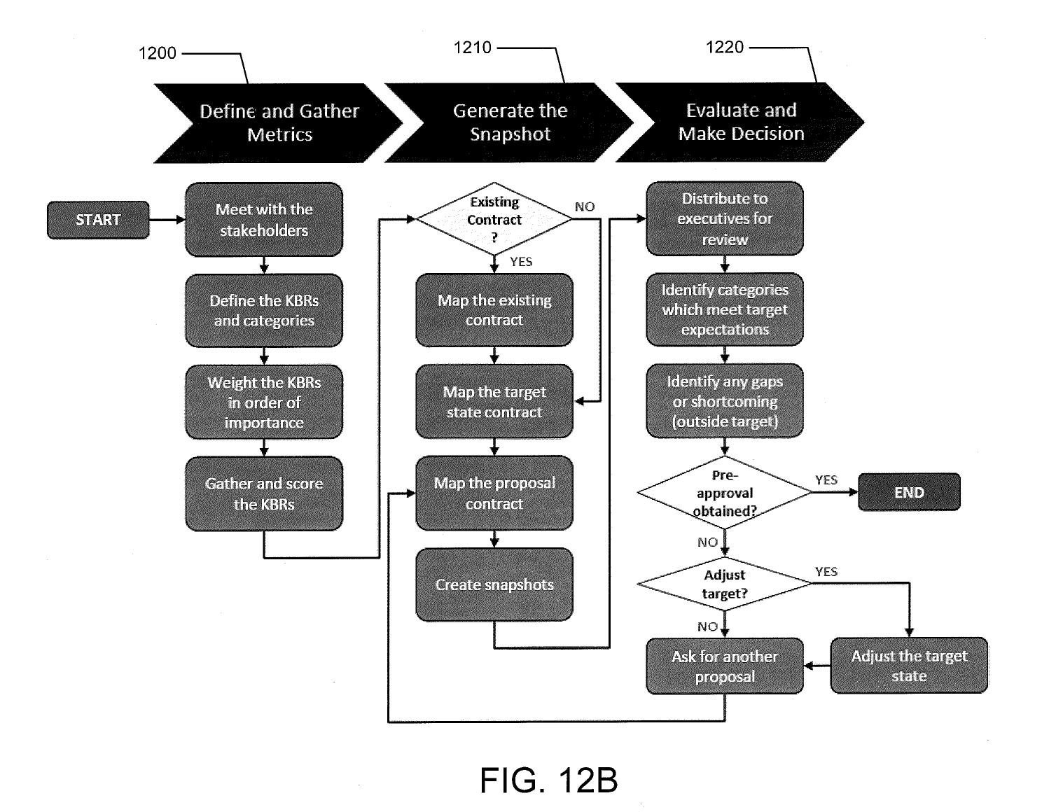

FIGS. 12A and 12B illustrate another aspect of the invention. FIGS. 12A and 12B include portions of the description and figures discussed above. Generally, FIGS. 12A and 12B illustrate a sample process that defines systems and methods that generate a graphical representation and allows the comparison between: 1) a set of contract or deal business requirements; 2) a contract or deal proposed by a vendor; and 3) a contract or deal that currently exists as viewed in the present time. The relative comparisons may be completed on key areas of the contract where key business requirements (KBRs) and metrics have been uniquely defined, targeted, and weighed. The set of contract or deal business requirements may also be defined as a Target Contract or a desired contract state. The contract or deal proposed by the vendor may be as defined as a Proposal Contract or a potential contract state. The contract or deal that currently exists may be defined as an Existing Contract or a current contract state.

As illustrated in FIG. 12A, the process includes a define and gather metrics phase 1200, a generate the snapshot phase 1220, and a evaluate and make decision phase 1230. Each of the phases may generally include a number of steps that make up the phases. While FIG. 12A illustrates a high-level process flow diagram, FIG. 12B illustrates a more detailed process flow diagram which will be explained below.

As illustrated in FIG. 12A, the define and gather metrics phase 1200 includes a first step of organizing the stakeholders 1202. The stakeholders may be those individuals or organizations which have an interest in the contract and/or the completion and finalization of the contract. The stakeholders may include, but not be limited to the following: process owner or owner of the area in which the contract will be executed, sourcing managers, network or computing architecture, vendor managers, enterprise vendor managers, vendor administration, vendor relationship managers, risk/compliance managers, and finance. Other stakeholders may be contemplated with this step in accordance with aspects of this invention.

The define and gather metrics phase 1200 may also include another step of defining the metrics 1204. A set of metrics may be utilized in order to measure the Existing Contract, Target Contract, and Proposal Contract against each other. Metrics may be defined into main categories which may be used as legs or components of a visualization grid as will be described further below. These metrics may be chosen based on the KBR categories defined by the stakeholders. The KBRs can also have several subcategories for each category. FIG. 4 illustrates a sample chart 400 of KBRs and metrics for categories and subcategories.

The define and gather metrics phase 1200 may also include another step of weighting the metrics 1206. FIG. 6 illustrates a weighting table 600 that illustrates a sample method of weighting and scoring the metrics or the categories and sub-categories in accordance with aspects of this invention. As illustrated in the weighting table 600, there are seven different columns: Deal Category 610, Deal Sub-Category 620, Weighted Sub-Category 630, Normalized Range 640, Target Score 650, Existing Score 660, and Proposal Score 670. Additional, or less, columns may be utilized with this table without departing from this invention. In this example, the deal category 610 is financial, with the sub-categories 620 being: best in class pricing, lease versus buy, limits on additional products or services, limits on maintenance, budget compliance, concessions objectives, and cost objectives.

As illustrated in FIG. 6, the weighting and scoring the metrics may include the following steps. First, labeled with a “1”, the deal sub-categories 620 may be weighted by the stakeholders, by determining a weighted sub-category 630 percentage for each deal sub-category 620. When completing this step, it is important to ensure that each sub-category weight 630 adds up to 100% for each deal category 610.

Second, labeled with a “2”, a normalized range 640 is determined by taking the weighted sub-category percentages and defining a normalized range 640 (0 to 10 point scale) to score. To find the normalized ranges 640, the weighted sub-categories 630 may be divided by 100. Each of these normalized scores (target score 650, existing score 660, and proposal score 670) will fall within the normalized ranges 640.

Third, labeled with a “3”, a normalized score may be determined for each of the three different scores, target score 650, existing score 660, and proposal score 670. Various methods may be utilized to determine the normalized score. The weighted score for each of the different scores may be calculated by multiplying the weighted sub-category 630 by the normalized score. In one aspect of the invention, for binary (yes or no) questions or sub-categories 620, the score may either be 0% (no) or 100% (yes) of the maximum value in the normalized range. For example, “Did we achieve best in class pricing?” Answering “no” is equivalent to 0% of the maximum value, or 3.85, which is then calculated as 0 for the sub-category of best in class pricing. Answering “yes” is equivalent to 100% of the maximum value, or 3.85, which is then calculated as 3.85 for the sub-category of best in class pricing. In another aspect of the invention, for raw calculations, the score may be determined by the achievement level in terms of a percentage of the maximum value in the normalized range. For example, “How many of the 100 concessions did we receive?” Answering 46 concessions is equivalent to 46% of the maximum value, or 0.77, which is then calculated as 0.35 for the sub-category score for concessions objectives.

Fourth, labeled by a “4”, the target score 650 for each category may be generated by adding all the weighted scores of the sub-categories. The existing score 660 and the proposal score 670 may be generated in the same fashion.

Following the define and gather metrics phase 1200 is the generate the snapshot phase 1210 as illustrated in FIG. 12A. The generate the snapshot phase 1210 may include the step of defining the target contract step 1212. During the define the target contract step 1212, the stakeholders and/or owners of each category determine the target for each of the categories. For example, the stakeholders and/or owners of the Finance category 510 determine an expected or desired value for the Finance category 510. Additionally, the stakeholders and/or owners of the Service Quality category 520 determine an expected or desired value for the Service Quality category 520. Additionally, the stakeholders and/or owners of the Risk category 530 determine an expected or desired value for the Risk category 530. Additionally, the stakeholders and/or owners of the Capabilities category 540 determine an expected or desired value for the Capabilities category 540. Additionally, the stakeholders and/or owners of the Partnership category 550 determine an expected or desired value for the Partnership category 550. FIG. 8 illustrates an example visualization model or snapshot tool 500 with the target contract 506 established.

The generate the snapshot phase 1210 may also include another step of mapping the existing contract 1214. In this step the visualization model or snapshot tool 500 as illustrated in FIG. 5 may be utilized. The weighted scores (as illustrated and described with FIG. 6) determined previously for the existing contract may then be mapped on the legs for each category. For example, the weighted scores for the existing contract for financial category may be mapped along the Financial leg 510. The weighted scores for the existing contract for the risk category may be mapped along the Risk leg 520. The weighted scores for the existing contract for the partnership category may be mapped along the Partnership leg 530. The weighted scores for the existing contract for the capabilities category may be mapped along the Capabilities leg 540. The weighted scores for the existing contract for the service quality category may be mapped along the Service Quality leg 550.

The generate the snapshot phase 1210 may also include another step of mapping the proposal contract 1216. In this step the visualization model or snapshot tool 500 as illustrated in FIG. 5 may be utilized. The weighted scores (as illustrated and described with FIG. 6) determined previously for the proposal contract may then be mapped on the legs for each category. For example, the weighted scores for the proposal contract for financial category may be mapped along the Financial leg 510. The weighted scores for the proposal contract for the risk category may be mapped along the Risk leg 520. The weighted scores for the proposal contract for the partnership category may be mapped along the Partnership leg 530. The weighted scores for the proposal contract for the capabilities category may be mapped along the Capabilities leg 540. The weighted scores for the proposal contract for the service quality category may be mapped along the Service Quality leg 550.

Following the generate the snapshot phase 1210 is the evaluate and make decision phase 1220 as illustrated in FIG. 12A. The evaluate and make decision phase 1220 may include the step of identifying the shortcomings of the proposed contract step 1222. During the identify the shortcomings of the proposed contract step 1222, the stakeholders and/or the owners of each of the categories first identifies which categories proposed contract score is less than the target score. This can be easily accomplished by viewing the visualization model or the snapshot tool 500. The visualization model or the snapshot tool 500 may give executives the ability to quickly assess if the proposal contract meets the criteria set by the company without looking at the details of the terms and conditions. The visualization model or the snapshot tool 500 provides a clear understanding of what the contract/deal is trying to achieve. Additionally, the visualization model or the snapshot tool 500 provides a quick visual view of where the organization stands in terms of achieving the target. Additionally, the visualization model or the snapshot tool 500 provides a mechanism to allow for pre-approval of a deal if the organization meets or exceeds all targets.

FIGS. 10A, 10B, and 10C illustrate utilizing the visualization model or the snapshot tool 500. FIG. 10A illustrates the target state 508, which shows the boundary area where an organization wants the proposal contract 506 to lie within. FIG. 10B illustrates the existing contract 504 which defines an area that shows the current state of the organization's contract with the vendor. FIG. 10C illustrates the proposal contract 506 which shows the areas where there is no overlap (if any) and overextends outside the area defined by the existing contract 504. The gap 509 illustrated is where the proposal contract 506 comes up short and is defined as the area between the proposal contract 506 and the target contract 508.

The evaluate and make decision phase 1220 may also include the step of identify areas to give back on the proposed contract 1224. After the stakeholders or category owners identify the shortcomings of the contract, the stakeholders or category owners may attempt to give back on the proposed contract and/or resolve these shortcomings. The visualization model or snapshot tool 500 may provide the stakeholders or category owners the ability to target specific areas or categories of the proposal contract to give back on. The stakeholders or category owners may then focus on these categories in order to attempt to resolve the shortcomings of the proposal contract.

FIG. 12B illustrates a detailed process flow framework similar to the process described above with FIG. 12A. FIG. 12B illustrates three different phases, a define and gather metrics phase 1200, a generate the snapshot phase 1210, and an evaluate and make decision phase 1220. The define and gather metrics phase 1200 may include the steps of: meeting with stakeholders, followed by defining the key business requirements (KBRs) and categories, weighting the KBRs in order of importance, and gathering and scoring the KBRs. The generate the snapshot phase 1210 may include the steps of: determining if there is an existing contract and mapping the existing contract if there is an existing contract, mapping the target contract, mapping the proposal contract, and creating snapshots for the existing contract, target state contract, and the proposal contract. The evaluate and make decision phase 1220 may include the steps of: distributing the snapshots to executives for review, identifying categories which meet the target expectations, identifying any gaps or shortcomings (outside of target), and determining if pre-approval is obtained. If pre-approval is not obtained, then the executives or stakeholders may adjust the target or ask for another proposal contract. If there is another proposal contract or if the target state is adjusted, the proposal contract and/or target state contract may be required to be mapped again in order to re-evaluate. This may be an iterative process until the pre-approval is obtained or the executives are willing to approve the proposal contract with the shortcomings identified.

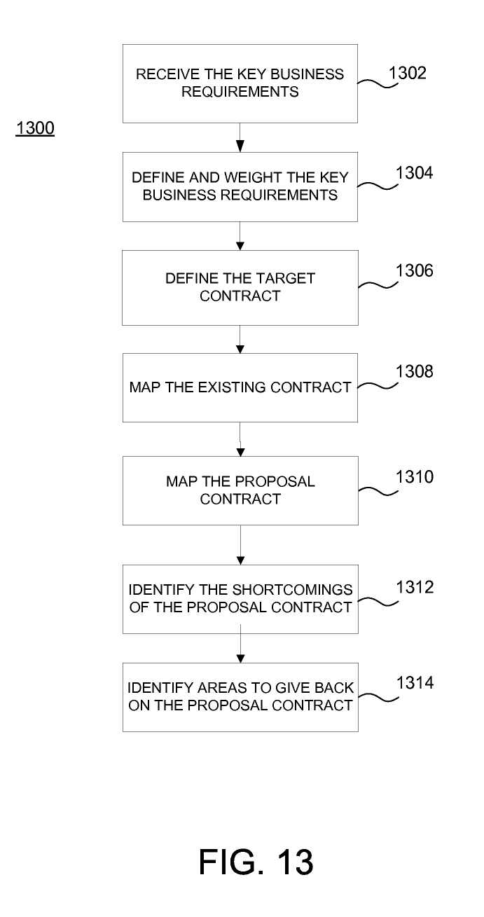

FIG. 13 may be based on FIGS. 12A and 12B and the description regarding FIGS. 12A and 12B. FIG. 13 illustrates a flow chart 1300 for systems and methods that generate a graphical representation and allows the comparison between: 1) a set of contract or deal business requirements; 2) a contract or deal proposed by a vendor; and 3) a contract or deal that currently exists as viewed in the present time. In a first step 1302, the system and methods may include the step of receiving the key business requirements (KBRs). In a second step 1304, the system and methods may include the step of defining and weighting the key business requirements (KBRs). In a third step 1306, the system and methods may include the step of defining a target contract. In a fourth step 1308, the system and methods may include the step of mapping an existing contract. In a fifth step 1310, the system and methods may include the step of mapping a proposal contract. In a sixth step 1312, the system and methods may include the step of identifying the shortcomings of the proposal contract. In a seventh step 1314, the system and methods may include the step of identifying areas to give back to on the proposal contract.

In another aspect of the invention, the key business requirement (KBR) may include the KBR of Business. The possible sub-categories under the Business KBR may include but not be limited to: regulation, which includes economic, industry, and competition; environment, which includes complexity, number of users, type of users, geography, and volume; and structure, which includes autonomy, strategies and policies, and organization change.

In another aspect of the invention, the key business requirement (KBR) may include the KBR of Financial. The possible sub-categories under the Financial KBR may include but not be limited to: financial, which may include responsiveness, types of SLAs, risk, reward/earnback, volume variations, and termination; and environment, which may include location, legislation, resource/skill availability, infrastructure, taxation, and technology availability.

In another aspect of the invention, the key business requirement (KBR) may include the KBR of Contractual. The possible sub-categories under the Contractual KBR may include but not be limited to: contract length, extension, number of SLAs, renegotiation, benchmarking, exclusivity, peer group instructions, and termination.

In another aspect of the invention, the key business requirement (KBR) may include the KBR of Processes. The possible sub-categories under the Processes KBR may include but not be limited to: delivery of IT services, which may include disaster/recovery, security, scope of delivery, and infrastructure provision (warranty/out-of warranty and dispatch); and support of IT services, which may include technology specific, industry specific, asset management, and procurement.

In another aspect of the invention, the key business requirement (KBR) may include the KBR of Maturity. The possible sub-categories under the Maturity KBR may include but not be limited to: service provider relationship, strategic importance, vendor capacity, presence, vision/strategy, awareness/reputation, business drivers, performance, agility, personnel, execution, price/cost, services, technologies, and financials.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. A computer-assisted method of assessing a vendor contract, the method comprising:
defining a set of category norms associated with a contract;
weighting, by a processor, the set of category norms;
mapping, using a processor, a set of existing contract scores associated with an existing contract to the category norms;
determining, using a processor, a set of target contract scores associated with a set of key business requirements;
mapping, using a processor, a set of proposal contract scores to the set of target contract scores, wherein the set of proposal contract scores are associated with a proposal contract; and
identifying a set of shortcomings between the set of proposal contract scores and the set of target contract scores.

2. The method of claim 1, wherein the set of existing contract scores is determined, by a processor, by multiplying a weight and a normalized score from 0-10.

3. The method of claim 1, wherein the set of target contract scores is determined, by a processor, by multiplying a weight and a normalized score from 0-10.

4. The method of claim 1, wherein the set of proposal contract scores is determined, by a processor, by multiplying a weight and a normalized score from 0-10.

5. The method of claim 1, wherein the mapping of the set of existing contract scores, the set of target contract scores, and the set of proposal contract scores utilizes a visualization grid with a set of legs with a normalized range from 0-10.

6. The method of claim 1, wherein the set of legs represents one or more of the following key business requirement categories: financial, service quality, risk, capabilities, and/or partnership.

7. The method of claim 1, wherein the visualization grid includes a gap defined as the area between the set of proposal contract scores and the set of target contract scores.

8. A computer-readable storage medium storing computer-executable instructions that, when executed, cause a processor to perform a method comprising:
receiving a set of key business requirements organized into a set of categories;
weighting, by a processor, the set key business requirements;
scoring, using a processor, the set of key business requirements for an existing contract, a target contract, and a proposal contract;
mapping, using a processor, the scores of the set of key business requirements for the existing contract, wherein the mapping is on a visualization model that includes a set of legs for each of the set of categories of key business requirements;
mapping, using a processor, the scores of the set of key business requirements for the target contract, wherein the mapping is on the visualization model;
mapping, using a processor, the scores of the set of key business requirements for the proposal contract, wherein the mapping is on the visualization model; and
identifying a set of shortcomings between the scores of the set of key business requirements for the proposal contract and the scores of the set of key business requirements for the target contract.

9. The method of claim 8, wherein the scores of the set of key business requirements for the existing contract is determined, by a processor, by multiplying the weight for each key business requirement and a normalized score from 0-10 for each key business requirement.

10. The method of claim 9, wherein the normalized score is determined as 0 or 10 for binary questions or categories.

11. The method of claim 9, wherein the normalized score is determined as a percentage for raw calculation questions or categories.

12. The method of claim 8, wherein the scores of the set of key business requirements for the target contract is determined, by a processor, by multiplying the weight for each key business requirement and a normalized score from 0-10 for each key business requirement.

13. The method of claim 12, wherein the normalized score is determined as 0 or 10 for binary questions or categories.

14. The method of claim 12, wherein the normalized score is determined as a percentage for raw calculation questions or categories.

15. The method of claim 8, wherein the scores of the set of key business requirements for the proposal contract is determined, by a processor, by multiplying the weight for each key business requirement and a normalized score from 0-10 for each key business requirement.

16. The method of claim 15, wherein the normalized score is determined as 0 or 10 for binary questions or categories.

17. The method of claim 15, wherein the normalized score is determined as a percentage for raw calculation questions or categories.

18. The method of claim 8, wherein the categories are defined by one or more of the following key business requirements: financial, service quality, risk, capabilities, and/or partnership.

19. An apparatus comprising:
at least one memory; and
at least one processor coupled to the at least one memory and configured to perform, based on instructions stored in the at least one memory:
receiving a set of key business requirements organized into a set of categories;
weighting, by the processor, the set key business requirements;
determining, by the processor, an existing contract score, for each of the key business requirements, wherein the existing contract score is determined by multiplying the weight for each key business requirement and a normalized score from 0-10 for each key business requirement associated with an existing contract;
determining, by the processor, a target contract score for each of the key business requirements, wherein the target contract score is determined by multiplying the weight for each key business requirement and a normalized score from 0-10 for each key business requirement associated with a target contract;
determining, by the processor, a proposal contract score for each of the key business requirements, wherein the proposal contract score is determined by multiplying the weight for each key business requirement and a normalized score from 0-10 for each key business requirement associated with a proposal contract;
mapping, using the processor, the existing contract scores, wherein the mapping is on a visualization model that includes a set of legs for each of the set of categories of key business requirements;
mapping, using the processor, the target contract scores, wherein the mapping is on the visualization model;
mapping, using the processor, the proposal contract scores, wherein the mapping is on the visualization model; and
identifying a set of shortcomings between the proposal contract scores and the target contract scores.

20. The apparatus of claim 19, wherein the categories are defined by one or more of the following key business requirements: financial, service quality, risk, capabilities, and/or partnership.
